(19) United States
(12) Patent Application Publication
(10) Pub. No.: US 2013/0316822 A1
(43) Pub. Date: Nov. 28, 2013

(54) Electronic Code Display Device

(71) Applicant: Platinum Plus Printing, LLC, Maple Lake, MN (US)

(72) Inventor: Carl Hensley, Somerset, WI (US)

(73) Assignee: Platinum Plus Printing, LLC, Maple Lake, MN (US)

(21) Appl. No.: 13/894,780

(22) Filed: May 15, 2013

Related U.S. Application Data
(60) Provisional application No. 61/648,862, filed on May 18, 2012.

(51) Int. Cl. G07F 17/32

(52) U.S. Cl. CPC G07F 17/3202
USPC 463/31

(57) ABSTRACT

Apparatus and associated methods relate to an electronic code display device which illuminates a code in response to user action. In an illustrative example, the user may remove a pull tab from the device permitting electrical connection between the power source and internal circuitry to provide illumination and/or code generation. In some embodiments, the code illuminated by the user's action may determine a prize amount or eligibility. In some examples, the device may comprise a small and light handheld unit to permit mailing for promotional or marketing campaigns. In some examples, the device may display a code for a lottery game, the code being indicative of a monetary amount won. In an illustrative example, the device may generate a randomly generated code, and in other examples, the device may display a pre-programmed code. In some examples, the code displayed may comprise numbers, letters, or a combination of both.

### CROSS-REFERENCE TO RELATED APPLICATIONS

This application claims benefit of priority to U.S. Provisional Application Ser. No. 61/648,862, filed by Hensley, C. on May 18, 2012 and entitled “Electronic Code Display Device,” the entire disclosure of which is incorporated herein by reference.

### TECHNICAL FIELD

The present application relates to a gaming device and more particularly to an electronic device that displaying an illuminated code for determination of a prize amount or eligibility.

### BACKGROUND

Many businesses depend upon baubles and trinkets for marketing and promotional purposes. These baubles and trinkets are often given away at conventions, demonstrations, and business calls. Businesses know that people enjoy getting something for free. Some of these giveaways have an additional gaming element to increase the excitement of the recipient of the trinket. These trinkets must be cheap and small to permit a business to widely distribute them for free.

The gaming industry is a multibillion dollar industry in the US alone. Its popularity plays upon people's desire to get something for nothing. So many people enjoy such a possibility that even non-gaming businesses sometimes employ gaming methods to promote their wares. The business idea is to exploit a potential customers' excitement so as to keep the offered product or service on the minds of the potential customers.

### SUMMARY

Apparatus and associated methods relate to an electronic code display device which illuminates a code in response to user action. In an illustrative example, the user may remove a pull tab from the device permitting electrical connection between the power source and internal circuitry to provide illumination and/or code generation. In some embodiments, the code illuminated by the user's action may determine a prize amount or eligibility. In some examples, the device may comprise a small and light handheld unit to permit mailing for promotional or marketing campaigns. In some examples, the device may display a code for a lottery game, the code being indicative of a monetary amount won. In an illustrative example, the device may generate a randomly generated code, and in other examples, the device may display a pre-programmed code. In some examples, the code displayed may comprise numbers, letters, or a combination of both.

In an illustrative embodiment, the device may display the code once activated by the user. In some implementations, the device may include power saving functionality. For example, the device may include a switching functionality to permit for deactivation of the device or disconnection of the power source to conserve power. For example, after a user views the code and determines prize eligibility, it may be to the user's benefit to deactivate the device and conserve device power prior to claiming the prize. In some examples, the device may include an on/off switch for power conservation. In some examples, the device may include a magnetic switching device. For example, a Hall Effect sensor may vary an output voltage necessary to display the code in response to the presence of a magnetic field. In some examples, a photoelectric sensor may be used to activate and/or deactivate the device. In some examples, the pull tab may be reinserted within a slot of the device to reinstate a separation of the power source from the internal circuitry used to display the code, thus disabling the device and conserving power. In some examples, the power source comprises a battery.

Various embodiments may provide for one or more advantages. For example, certain embodiments may enhance or increase user interest in lottery or promotional games. For example, operating the electronic device may be of greater user interest than conventional lottery or promotional game pieces. In some embodiments, the device may generate sound to enhance user interest in the device. In some embodiments, the code displayed may flash or change colors. In some embodiments, indicia may be printed on the device or upon the display window to represent a particular game or company.

The details of various embodiments are set forth in the accompanying drawings and the description below. Other features and advantages will be apparent from the description and drawings, and from the claims.

### BRIEF DESCRIPTION OF THE DRAWINGS

FIG. 1 is an elevated front perspective view of an Electronic Code Display Device showing the new design.

FIG. 2 is a front elevation view of the embodiment of FIG. 1.

FIG. 3 is a rear elevation view of the embodiment of FIG. 1.

FIG. 4 is a first side elevation view of the embodiment of FIG. 1.

FIG. 5 is a second side elevation view of the embodiment of FIG. 1.

FIG. 6 is a top plan view of the embodiment of FIG. 1; the opposite side being a mirror image thereof.

FIGS. 7A-7H depict exemplary views of the Electronic Code Display Device.

Like reference symbols in the various drawings indicate like or similar elements.

### DETAILED DESCRIPTION OF ILLUSTRATIVE EMBODIMENTS

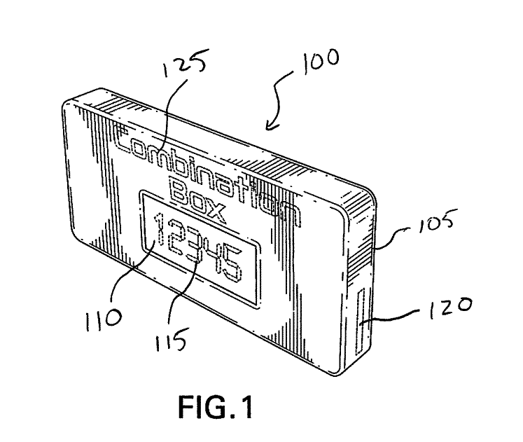

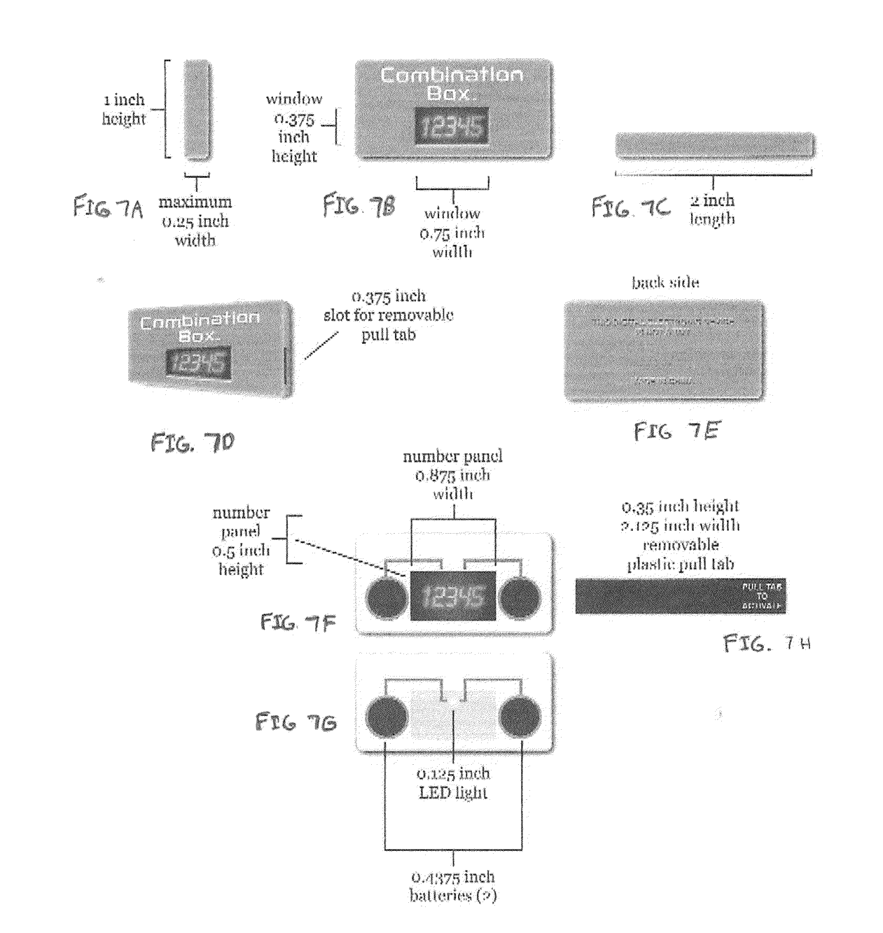

To aid understanding, this document is organized as follows. FIGS. 1 through 6 illustrate different views of an exemplary embodiment of an electronic code display device (ECDD). FIGS. 7A-7H depict different views of an exemplary embodiment of an ECDD showing exemplary dimensions. As described below, various embodiments may include current modulation functionality that may permit the user to selectively change the illumination state of the device, which may, in some examples, advantageously provide a mechanism to reduce power consumption and therefore substantially improve operational life and/or reduce energy storage (e.g., battery) requirements. Reduced battery requirements may, in some embodiments, achieve reduced size and cost, and/or render them substantially more environmentally friendly.

FIG. 1 is an elevated front perspective view of an electronic code display device showing the new design. In FIG. 1, a device 100 is shown comprising a housing 105. The housing 105 includes a front side, a rear side, a right side, a left side, a top side, and a bottom side. The housing 105 is comprised of a box-shape structure. In some embodiments, the housing 105 may comprise other shapes than as shown in FIG. 1. For example, in some embodiments the housing 105 may comprise a three-dimensional triangular or cubed shape. In some embodiments, the housing 105 may comprise a spherical or oval shape, for example, to conform to various applications. In some embodiments, at least one of the surfaces has a dimension greater than an adjacent side so as to form an overhang or lip, for example. In some embodiments, an overhang along one edge may provide a region with an aperture for coupling to another device (e.g., key ring).

The housing 105 includes a display window 110 upon the front side. The display window 110 comprises a transparent structure to permit for viewing of the code 115 therethrough. In some embodiments, for example, the display window 110 may comprise a translucent or transparent structure. In some embodiments, the display window 110 may include indicia, such as for example, words or letters formed thereon. In some examples, the indicia may be formed, for example, by deposition or material insertion, etching or material removal, or any of these alone or in combination, using ink, metallization, lasers, or other indicia forming techniques known to those of ordinary skill in this art. In some embodiments, the display window 110 may be located upon one or more other sides of the housing 105 rather than solely the front side. For example, at least one additional window may be formed in each side of the ECDD.

In an illustrative example, the electronic code 115 may be matched with a code key (not shown) for determination of prize eligibility or amount. For example, if a code “12345” signified an amount of $5 in a code key, the user would win $5. In another example, if the code “12345” signified a 10% discount in the code key, the user may receive a 10% discount at a participating establishment (e.g., restaurant, clothing store). In some examples, each device 100 may be programmed to display a single pre- determined code 115 to correlate with a specific prize determination. In some examples, each device may generate one or more random codes 115 to correlate with one or more prizes. In some examples, the code 115 may not correlate with any prizes, thus making the device 100 a non-winner. In some examples, the code 115 may include all letters. In some examples, the code 115 may include all numbers. In some examples, the code 115 may include a combination of numbers and letters. In some examples, the code 115 may include one or more symbols or pictorial graphics.

In the depicted example, the housing 105 also includes a slot 120 along the right side. The slot 120 is for receiving a pull tab that is inserted within the housing 105 to provide for a separation of the power source and the internal circuitry. When the pull tab is located within the slot 120 in a fully inserted position, the pull tab prevents the power source from making contact with the circuitry and thus substantially prevents or limits release of energy from the power source, thus enabling prolonged shelf life of the power source and device 100. The pull tab serves as an insulator to separate to mechanical contacts. Once the pull tab is removed from the slot 120, a closed circuit is completed by closing of mechanical contacts, whereby the power source couples energy to the circuitry to illuminate and cause the code 115 to become visible. The slot 120 may be located upon one or more other sides of the housing 105 rather than solely the right side.

The housing 105 also includes printed indicia 125 upon the front side. In some examples, the printed indicia 125 may represent the game being played. In some examples, the indicia 125 may represent the company or marketer. The indicia 125 may be located upon one or more other sides of the housing 105 rather than solely the front side.

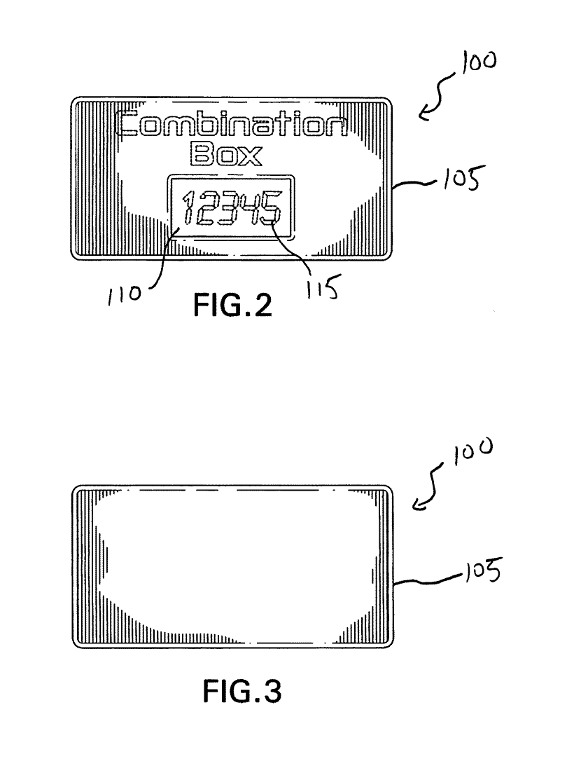

FIG. 2 is a front elevation view of the embodiment of FIG. 1. The rectangular shape of the front side of the housing 105 is shown in FIG. 2.

FIG. 3 is a rear elevation view of the embodiment of FIG. 1. The rectangular shape of the rear side of the housing 105 is shown in FIG. 2. The rear side mirrors the front side in shape. However, as shown in FIG. 3, the rear side may not include the display window 110.

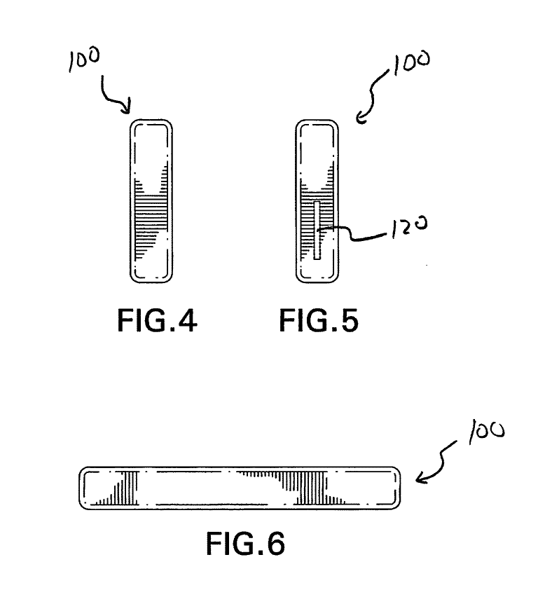

FIG. 4 is a first side elevation view of the embodiment of FIG. 1. The rectangular shape of the first side of the housing 105 is shown in FIG. 4.

FIG. 5 is a second side elevation view of the embodiment of FIG. 1. The rectangular shape of the second side of the housing 105 is shown in FIG. 5. The second side mirrors the first side in shape. However, as shown in FIGS. 4 and 5, the first side and the second side may differ in that the second side may include a slot 120 for the pull tab.

FIG. 6 is a top plan view of the embodiment of FIG. 1; the opposite side being a mirror image thereof. As described previously, the housing 105 and any one or more of the sides may comprise different shaped structures.

FIGS. 7A-7H depict exemplary views of the electronic code display device. In FIGS. 7A-7H, various exemplary dimensions of the device are shown. The exemplary dimensions represent a device small in size such as to enable cost-effective postal mailing or easy transfer of the device to one or more customers. The device may also be light in weight to enable cost-effective postal mailing. The power source being batteries and internal circuitry including an LED light is displayed in FIGS. 7F and 7G. An exemplary pull tab is displayed in FIG. 7H. In some embodiments, the pull tab is received and removed through the slot along the right side of the housing to permit the batteries to make contact with the internal circuitry and cause the LED light to be illuminated which illuminates the code.

In an illustrative embodiment the toggling between the displaying of the game code and the hiding of the game code may result from the pulling of a pull-tab. In this way, the code may be obscured when the pull-tab is inserted into the ECDD. In some embodiments, the pull-tab may be re-insertable into the ECDD. In other embodiments the pull-tab may not be re-insertable into the ECDD. In various embodiments, the toggling between the revealed code and the hidden code may be accomplished by the completion of an illumination circuit. This completion may result from the connection of circuit contacts when the pull-tab is removed from the ECDD. The toggling may be performed by a reed switch completing an illumination circuit when a magnet is placed in the proximity of the ECDD, for example. In some embodiments, the toggling may be manually performed by a user toggling of an on/off switch, for example. In an exemplary embodiment, the on/off switch may only permit illumination of the code after the pull-tab has been removed from the ECDD.

Although various embodiments have been described with reference to the figures, further embodiments are possible. For example, the housing may be formed of plastic materials. In some examples, the housing may be formed of a metal or wood material. The housing may include an access panel to access the power source (e.g., batteries) for removal or replacement. In some embodiments, the housing may comprise a waterproof structure. In some examples, the device may be reusable and in some examples the device may be intended for a one time use or disposable structure.

In various embodiments, the shape of the housing may be adapted to special shapes or sizes to suggest desired applications. By way of example and not limitation, the housing may be shaped and sized to appear in the likeness of a car or animal (e.g., swan, elephant). The dimensions of the display screen may be varied to suit the desired implementation. For example, the display screen may be sized to fit along a face of an ordinary sized pen, or may be increased to fit in any suitable area for visual display from a distance.

In some implementations, integrity of the housing may be important to detect and/or prevent fraudulent activity, such as consumer tampering or opening of the case to access the code therein without, for example, activation by pull tab.

The device may include attachments or functionality for other items or purposes. For example, the housing may include a key chain attachment. In some examples, the device may include a light, such as an LED light, for use as a flashlight. The light source that illuminates the code may provide a second use as a local light source. For example, a second aperture in the housing may be transmitted as an external beam passing through a lens disposed in the housing wall. In some embodiments, the flashlight light source may be illuminated by a second light source that is different than the light source that illuminates the code. The second light source may include some or all of the light source used to illuminate the code. The flashlight may be powered through the internal power source or an external power source.

The device may include various circuitry and components to enable powering of the device and display of the code. In some examples, the device may include one or more solar elements for collection of solar light to power the device. In some examples, the device may include components to function by electromagnetic induction. For example, the device may include a hand crank which induces a time-varying magnetic field with respect to a wire coil, thereby inducing a voltage capable of transferring electrical power to the circuit for operation (e.g., illumination to display the code) and/or storage (e.g., battery, capacitor).

In some embodiments, the device may include an infrared or photo sensors to enable or disable the code displaying circuitry in response to the presence or absence of a light source or focused beam.

In some embodiments, the device may include an on/off toggle switch to enable/disable the circuitry. In some embodiments, the device may include a photo transistor in communication with the internal circuitry to enable and/or disable the light for illuminating the code in response to an incident light source. In some implementations, the ECDD may respond to the incident light source only if the incident light source contains a predetermined wavelength range (e g , infrared, UV-A)

The code may be displayed via a plurality of lights or LEDs arranged in a specific pattern to represent the intended code. In some embodiments, a pre-printed reflective pattern may be present upon the inside or outside of the display window which is illuminated upon the illumination of the light source (e.g., LED). In some embodiments, the code illuminated may be fixed or stationary. In some embodiments, the code illuminated may move, such as for example scroll from left to right, or blink.

In one exemplary aspect, a game token device for hiding and revealing a game code includes a substantially orthorhombic box having a first dimension no bigger than two and one-half inches, a smaller second dimension no bigger than one and one-fourth inches, an even smaller third dimension no bigger than one-third of an inch, a substantially planar top face having both the first dimension and the second dimension, a substantially planar orthogonal face having both the second dimension and the third dimension, and an interior. The device further includes a display window in the substantially planar top face, the display window capable of displaying a game code comprising symbols, the display window having an obscure state and an illuminative state, the obscure state hiding the game code and the illuminative state revealing the game code. The device further includes a substantially planar dielectric separator having a length that is at least two inches, a smaller width that is substantially uniform for most of the length, and a substantially uniform thickness that is no greater than one-twentieth of an inch, the substantially uniform width being no greater than one-half an inch, the substantially planar dielectric separator capable of being located in an inserted position in which most of the substantially uniform width portion of the dielectric separator resides in the interior of the substantially orthorhombic box. The device further includes an activation aperture in the orthogonal face capable of providing the dielectric separator access to the interior of the substantially orthorhombic box, the activation aperture having a major dimension sized to receive the dielectric separator's substantially uniform width and having a minor dimension sized to receive the dielectric separator's thickness such that the dielectric separator is slidably removable from the substantially orthorhombic box. The device further includes an activation contact comprising a top terminal and a bottom terminal, the top terminal and the bottom terminal located in the interior of the substantially orthorhombic box, and separated by the thickness of the dielectric separator being juxtaposed on top and bottom of the substantially planar dielectric separator when the dielectric separator is in the inserted position, the terminals making contact with each other when the dielectric separator is slidably removed from the substantially orthorhombic box. The device further includes an illumination circuit located in the interior of the substantially orthorhombic box, the illumination circuit being completed when the top terminal and the bottom terminal make contact with each other, the illumination circuit putting the display window in the illuminative state when the circuit is completed and putting the display window in the obscure state when the dielectric separator is in the inserted position.

In various examples, the illumination circuit may include a battery. The game code may be predetermined. The illumination circuit may determine the game code using a pseudo-random code generation algorithm, the game code being determined as a consequence of the removal of the dielectric separator. The device may further include an on/off switch capable of toggling between the obscure state and the illuminative state after the removal of the dielectric separator. The symbols may include numbers, letters, or a combination of both. The illumination circuit may generate sound when completed.

In another exemplary aspect, a method of revealing and obscuring a game code includes a number of steps. One step provides a substantially orthorhombic box having a first dimension no bigger than two and one-half inches, a smaller second dimension no bigger than one and one-fourth inches, an even smaller third dimension no bigger than one-third of an inch, a substantially planar top face having both the first dimension and the second dimension, a substantially planar orthogonal face having both the second dimension and the third dimension, and an interior. Another step includes selectively revealing a game code in a display window in the substantially planar top face, the display window capable of displaying the game code comprising symbols, the display window having an obscure state and an illuminative state, the obscure state hiding the game code and the illuminative state revealing the game code. A further step includes inserting a substantially planar dielectric separator into the interior of the substantially orthorhombic box, the dielectric separation having a length that is at least two inches, a smaller width that is substantially uniform for most of the length, and a substantially uniform thickness that is no greater than one-twentieth of an inch, the substantially uniform width being no greater than one-half an inch. A further step includes receiving a dielectric separator into the interior of the substantially orthorhombic box through an activation aperture in the orthogonal face, the activation aperture having a major dimension sized to receive the dielectric separator's substantially uniform width and having a minor dimension sized to receive the dielectric separator's thickness such that the dielectric separator is slidably removable from the substantially orthorhombic box. Another step includes providing an activation contact comprising a top terminal and a bottom terminal, the top terminal and the bottom terminal located in the interior of the substantially orthorhombic box, and separated by the width of the dielectric separator being juxtaposed on top and bottom of the substantially planar dielectric separator when the dielectric separator is in the inserted position, the terminals making contact with each other when the dielectric separator is slidably removed from the substantially orthorhombic box. A further step includes selectively completing an illumination circuit located in the interior of the substantially orthorhombic box, the illumination circuit being completed when the top terminal and the bottom terminal make contact with each other, the illumination circuit putting the display window in the illuminative state when the circuit is completed and putting the display window in the obscure state when the dielectric separator is in the inserted position.

In various implementations of the method, the illumination circuit may include a battery. The game code may be predetermined. The method may further include determining the game code using a pseudo-random code generation algorithm, the game code being determined as a consequence of the removal of the dielectric separator. The method may include selectively hiding and revealing the game code by use of an on/off switch capable of toggling between the obscure state and the illuminative state after the removal of the dielectric separator. The symbols may include numbers, letters, or a combination of both. Predetermined sounds may be emitted when the illumination circuit is completed.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A game token device for hiding and revealing a game code, the device comprising:
a substantially orthorhombic box having a first dimension no bigger than two and one-half inches, a smaller second dimension no bigger than one and one-fourth inches, an even smaller third dimension no bigger than one-third of an inch, a substantially planar top face having both the first dimension and the second dimension, a substantially planar orthogonal face having both the second dimension and the third dimension, and an interior;
a display window in the substantially planar top face, the display window capable of displaying a game code comprising symbols, the display window having an obscure state and an illuminative state, the obscure state hiding the game code and the illuminative state revealing the game code;
a substantially planar dielectric separator having a length that is at least two inches, a smaller width that is substantially uniform for most of the length, and a substantially uniform thickness that is no greater than one-twentieth of an inch, the substantially uniform width being no greater than one-half an inch, the substantially planar dielectric separator capable of being located in an inserted position in which most of the substantially uniform width portion of the dielectric separator resides in the interior of the substantially orthorhombic box;
an activation aperture in the orthogonal face capable of providing the dielectric separator access to the interior of the substantially orthorhombic box, the activation aperture having a major dimension sized to receive the dielectric separator's substantially uniform width and having a minor dimension sized to receive the dielectric separator's thickness such that the dielectric separator is slidably removable from the substantially orthorhombic box;
an activation contact comprising a top terminal and a bottom terminal, the top terminal and the bottom terminal located in the interior of the substantially orthorhombic box, and separated by the thickness of the dielectric separator being juxtaposed on top and bottom of the substantially planar dielectric separator when the dielectric separator is in the inserted position, the terminals making contact with each other when the dielectric separator is slidably removed from the substantially orthorhombic box; and
an illumination circuit located in the interior of the substantially orthorhombic box, the illumination circuit being completed when the top terminal and the bottom terminal make contact with each other, the illumination circuit putting the display window in the illuminative state when the circuit is completed and putting the display window in the obscure state when the dielectric separator is in the inserted position.

2. The game token device of claim 1, wherein the illumination circuit comprises a battery.

3. The game token device of claim 1, wherein the game code is predetermined.

4. The game token device of claim 1, wherein the illumination circuit determines the game code using a pseudo-random code generation algorithm, the game code being determined as a consequence of the removal of the dielectric separator.

5. The game token device of claim 1, further comprising an on/off switch capable of toggling between the obscure state and the illuminative state after the removal of the dielectric separator.

6. The game token device of claim 1, wherein the symbols comprise numbers.

7. The game token device of claim 1, wherein the symbols comprise letters.

8. The game token device of claim 1, wherein the symbols comprise letters and numbers.

9. The game token device of claim 1, wherein the illumination circuit generates sound when completed.

10. A method of revealing and obscuring a game code, the method comprising:
providing a substantially orthorhombic box having a first dimension no bigger than two and one-half inches, a smaller second dimension no bigger than one and one-fourth inches, an even smaller third dimension no bigger than one-third of an inch, a substantially planar top face having both the first dimension and the second dimension, a substantially planar orthogonal face having both the second dimension and the third dimension, and an interior;
selectively revealing a game code in a display window in the substantially planar top face, the display window capable of displaying the game code comprising symbols, the display window having an obscure state and an illuminative state, the obscure state hiding the game code and the illuminative state revealing the game code;
inserting a substantially planar dielectric separator into the interior of the substantially orthorhombic box, the dielectric separation having a length that is at least two inches, a smaller width that is substantially uniform for most of the length, and a substantially uniform thickness that is no greater than one-twentieth of an inch, the substantially uniform width being no greater than one-half an inch;
receiving a dielectric separator into the interior of the substantially orthorhombic box through an activation aperture in the orthogonal face, the activation aperture having a major dimension sized to receive the dielectric separator's substantially uniform width and having a minor dimension sized to receive the dielectric separator's thickness such that the dielectric separator is slidably removable from the substantially orthorhombic box.
providing an activation contact comprising a top terminal and a bottom terminal, the top terminal and the bottom terminal located in the interior of the substantially orthorhombic box, and separated by the width of the dielectric separator being juxtaposed on top and bottom of the substantially planar dielectric separator when the dielectric separator is in the inserted position, the terminals making contact with each other when the dielectric separator is slidably removed from the substantially orthorhombic box; and
selectively completing an illumination circuit located in the interior of the substantially orthorhombic box, the illumination circuit being completed when the top terminal and the bottom terminal make contact with each other, the illumination circuit putting the display window in the illuminative state when the circuit is completed and putting the display window in the obscure state when the dielectric separator is in the inserted position.

11. The method of revealing and obscuring a game code of claim 10, wherein the illumination circuit comprises a battery.

12. The method of claim 10, wherein the game code is predetermined.

13. The method of claim 10, further comprising determining the game code using a pseudo-random code generation algorithm, the game code being determined as a consequence of the removal of the dielectric separator.

14. The method of claim 10, further comprising selectively hiding and revealing the game code by use of an on/off switch capable of toggling between the obscure state and the illuminative state after the removal of the dielectric separator.

15. The method of claim 10, wherein the symbols comprise numbers.

16. The game token device of claim 10, wherein the symbols comprise letters.

17. The method of claim 10, wherein the symbols comprise letters and numbers.

18. The method of claim 10, further comprising sounding of a predetermined sound when the illumination circuit is completed.

19. A game token device for hiding and revealing a game code, the device comprising:
a box having a substantially planer top surface, an orthogonal face, and an interior;
a display window in the substantially planar top face, the display window capable of displaying a game code comprising symbols, the display window having an obscure state and an illuminative state, the obscure state hiding the game code and the illuminative state revealing the game code;
a substantially planar dielectric separator having a length that is at least two inches, a smaller width that is substantially uniform for most of the length, and a substantially uniform thickness that is no greater than one-twentieth of an inch, the substantially uniform width being no greater than one-half an inch, the substantially planar dielectric separator capable of being located in an inserted position in which most of the substantially uniform width portion of the dielectric separator resides in the interior of the substantially orthorhombic box;
an activation aperture in the orthogonal face capable of providing the dielectric separator access to the interior of the substantially orthorhombic box, the activation aperture having a major dimension sized to receive the dielectric separator's substantially uniform width and having a minor dimension sized to receive the dielectric separator's thickness such that the dielectric separator is slidably removable from the substantially orthorhombic box; and
means for toggling between the obscure state and the illuminative state.

20. The game token device of claim 19, wherein the illuminative state further comprises an audible sound immediately after entering the state.
